(19) United States
(12) Patent Application Publication
(10) Pub. No.: US 2022/0396156 A1
(43) Pub. Date: Dec. 15, 2022

(54) DIRECT ELECTRIC VEHICLE CHARGER

(71) Applicant: GREEN POWER CO., LTD., Gyeonggi-do (KR)

(72) Inventor: Jung Goo CHO, Gyeonggi-do (KR)

(21) Appl. No.: 17/450,956

(22) Filed: Oct. 14, 2021

(30) Foreign Application Priority Data
Feb. 3, 2021 (KR) 10-2021-0015092
May 7, 2021 (KR) 10-2021-0059223

(51) Int. Cl. B60L 53/10; B60L 53/24; B60L 53/22; B60L 53/16; H02M 3/158; H02M 3/335

(52) U.S. Cl. CPC B60L 53/11; B60L 53/24; B60L 53/22; B60L 53/16; H02M 3/1582; H02M 3/33584; B60L 2210/10; B60L 2210/30

(57) ABSTRACT

The present disclosure relates to an electric vehicle fast charger, and provides a high-efficiency, low-cost electric vehicle fast charger by controlling a charging current and voltage using a simple non-isolated dc/dc converter after rectifying an output of a high voltage distribution transformer.

### CROSS-REFERENCE TO RELATED APPLICATIONS

The present application claims priority to Korean Patent Application No. 10-2021-0015092, filed on Feb. 3, 2021 and Korean Patent Application No. 10-2021-0059223, filed on May 7, 2021. The entire contents of the above-listed applications are hereby incorporated by reference for all purposes.

### TECHNICAL FIELD

The following disclosure relates to an electric vehicle fast charger and to providing a high-efficiency, low-cost electric vehicle fast charger by controlling a charging current and voltage using a simple non-isolated dc/dc converter after rectifying an output of a high voltage distribution transformer.

### BACKGROUND

The content described below merely provides background information related to the present embodiment and does not constitute the prior art.

Fossil energy has been the main source of energy for human life so far. However, there is a problem in using fossil energy in that reserves thereof are finite and a lot of pollution occurs as the fossil energy is consumed. Therefore, in recent years, in order to reduce pollution, the demand and supply for electric vehicles that obtain power using energy stored in batteries instead of the fossil energy are rapidly increasing. Accordingly, an electric vehicle charger market is also rapidly increasing.

As illustrated in FIG. 1 in a conventional electric vehicle charger, the charger is configured by converting a voltage to a standard low voltage (220 V, 380 V, etc.) through a high voltage distribution transformer in a distribution line, then rectifying the converted voltage, and using an isolated dc/dc converter. Meanwhile, since the electric vehicle charger must be electrically isolated between input and output, the isolated dc/dc converter is inevitably used.

The structure of the conventional electric vehicle charger has a problem in that the overall efficiency is only about 90% due to the sum of loss in the distribution transformer, loss in the circuit breakers such as an air circuit breaker (ACB) and a circuit breaker (CB) at a low voltage end, loss caused by a flow of large current in a low voltage cable, and losses in the rectifier and the insulated dc/dc converter. In addition, there is a problem in that the manufacturing cost of the charger greatly increases as it goes through several steps.

In addition, a function for vehicle-to-grid (V2G) that seeks to stabilize the system by regenerating the battery energy of the electric vehicle to the distribution line is recently required, but the existing charger does not have such a function.

### SUMMARY

An embodiment of the present disclosure is to provide a high-efficiency, low-cost electric vehicle charger by maximizing efficiency of the charger and reducing the cost.

The objects to be achieved by the present disclosure are not limited to the objects mentioned above, and other objects not mentioned will be clearly understood by those of ordinary skill in the art to which the present disclosure belongs from the description below.

In one general aspect, there is provided a direct charger capable of reducing the cost and maximizing efficiency by using an insulation function of a distribution transformer as an electrical insulation between input and output, which is an essential condition for an electric vehicle charger, and using a rectifier and a non-isolated dc/dc converter at an output of the distribution transformer. In this case, in order to satisfy a leakage current specification of the electric vehicle charger, a secondary winding of the distribution transformer needs to be designed to have a small stray capacitance with an adjacent object, and the rectifier needs to be a type of rectifier that does not perform high-frequency switching like a diode rectifier.

In addition, the electric vehicle charger according to the present disclosure may reduce the cost and loss of a circuit breaker, a cable, and the like at the rear end of the distribution transformer by making the distribution transformer as a transformer dedicated to the electric vehicle charger to adopt a high voltage such as 500 to 600 V according to a voltage of a battery of the recent electric vehicle instead of low voltages such as 220 V and 380 V, which are standard voltages, as an output voltage.

In addition, in another general aspect, there is provided a method of regenerating energy like a diode rectifier without using a high-frequency switching ac/dc converter even during energy regeneration for V2G.

### BRIEF DESCRIPTION OF THE FIGURES

FIG. 1 is a configuration diagram of a conventional electric vehicle charger;

FIG. 2 is a configuration diagram of an electric vehicle charger according to the present disclosure;

FIG. 3a is a configuration diagram of a conventional distribution transformer;

FIG. 3b is a cross-section diagram of a conventional distribution transformer;

FIG. 4 is an internal configuration diagram 1 of a distribution transformer for a direct electric vehicle charger;

FIG. 5 is an internal configuration diagram 2 of a distribution transformer for a direct electric vehicle charger;

FIG. 6 is an internal configuration diagram 3 of a distribution transformer for a direct electric vehicle charger;

FIG. 7 is a configuration diagram of a secondary winding of a distribution transformer for 12-pulse rectification in the direct charger;

FIG. 8 is a configuration diagram of a secondary winding of a distribution transformer for adding an active filter, an ESS, and a photovoltaic power generation function in the direct charger;

FIGS. 9a to 9f are explanatory diagrams of the configuration and operation principle of a buck converter and a booster converter for a non-isolated dc/dc converter;

FIG. 10a illustrates a configuration diagram of a direct charger including a diode rectifier, an LC filter, and a buck converter;

FIG. 10b is an operation waveform of a direct charger including a diode rectifier, an LC filter, and a buck converter;

FIG. 11a illustrates a configuration diagram of a direct charger including a diode rectifier, an LC filter, and a bidirectional buck converter;

FIG. 11b is an operation waveform of a direct charger including a diode rectifier, an LC filter, and a bidirectional buck converter;

FIG. 12 illustrates a configuration in which a bidirectional buck-boost converter is configured by adding bidirectional boost converters to an output of the bidirectional buck converter, and an inductor is shared with each other;

FIG. 13a is illustrates a configuration of a bidirectional booster-buck converter in which a bidirectional booster converter and a bidirectional buck converter are sequentially connected to a rear end of a three-phase rectifier;

FIGS. 13b to 13c is an operation waveforms of a bidirectional booster-buck converter in which a bidirectional booster converter and a bidirectional buck converter are sequentially connected to a rear end of a three-phase rectifier;

FIG. 14a illustrates a configuration diagram of a first auxiliary circuit for zero-voltage switching in the buck-boost converter;

FIG. 14b is an operation waveform (b) of a first auxiliary circuit for zero-voltage switching in the buck-boost converter;

FIG. 15 illustrates a configuration diagram of a second auxiliary circuit for zero-voltage switching in a unidirectional buck-boost converter;

FIG. 16 illustrates a configuration diagram of the second auxiliary circuit for zero-voltage switching when unidirectional power conversion is performed in a bidirectional buck-boost converter;

FIG. 17 illustrates a configuration diagram of a third auxiliary circuit for zero-voltage switching when bidirectional power conversion is performed in a bidirectional buck-boost converter;

FIG. 18a illustrates a configuration diagram of the second auxiliary circuit for zero-voltage switching in the bidirectional buck-boost converter;

FIG. 18b is an operation waveform (b) of the second auxiliary circuit for zero-voltage switching in the bidirectional buck-boost converter;

FIG. 19 illustrates a configuration diagram of the third auxiliary circuit for zero-voltage switching in the bidirectional booster-buck converter;

FIG. 20a illustrates a configuration diagram of a rectifier circuit capable of performing bidirectional power conversion for V2G;

FIG. 20b is an operation waveform (b) of a rectifier circuit capable of performing bidirectional power conversion for V2G;

FIG. 21 illustrates an operation waveform when a switching overlap occurs in a rectifier circuit capable of performing bidirectional power conversion for V2G;

FIG. 22a illustrates a configuration of a passive clamp circuit for giving a switching dead time in a rectifier circuit capable of performing bidirectional power conversion for V2G;

FIG. 22b is an operation waveform of a passive clamp circuit for giving a switching dead time in a rectifier circuit capable of performing bidirectional power conversion for V2G;

FIG. 23 illustrates a configuration of an active clamp circuit for giving a switching dead time in a rectifier circuit capable of performing bidirectional power conversion for V2G; and

FIG. 24 illustrates a configuration in which an ESS and a photovoltaic power generation device attached to a dc-link terminal of a direct charger capable of performing bidirectional power conversion for V2G are applied.

### DETAILED DESCRIPTION

Hereinafter, embodiments of the present disclosure will be described with reference to the accompanying drawings so that a person skilled in the art may easily implement the embodiments. It should be noted that reference numbers indicated for components or actions in the accompanying drawings use the same reference numbers as much as possible when indicating the same components or actions in other drawings. In the following, in describing the present disclosure, when it is determined that a detailed description of a related known function or a known configuration may unnecessarily obscure the gist of the present disclosure, the detailed description thereof will be omitted.

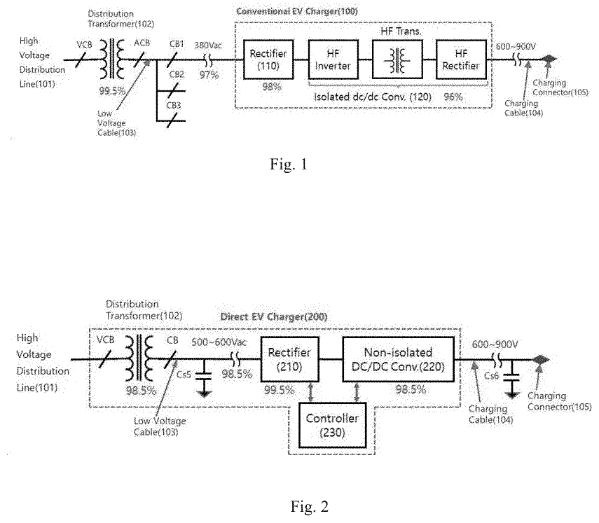

FIG. 1 is a configuration diagram of a conventional electric vehicle charger. As illustrated in FIG. 1, the conventional electric vehicle charger 100 converts a voltage to a standard low voltage (220 V, 380 V, etc.) through a distribution transformer 102 in a distribution line 101. In addition, the electric vehicle charger 100 includes a rectifier 110 receiving the converted voltage as an input and an isolated dc/dc converter 120 for electrical insulation and charging current control. This is because electrical insulation between input and output is essential in the electric vehicle charger. The voltage of the distribution line varies from country to country, and a voltage in the range of 10 kV to 30 kV is generally used. The voltage of the distribution line is, for example, 22.9 kV in Korea and 13.8 kV in the United States. In the case of the distribution line within a customer, a voltage in the range of 3 kV to 10 kV is used.

On the other hand, although not illustrated in FIG. 1, in general, the conventional electric vehicle charger 100 includes a high voltage circuit breaker (VCB), a fuse, a watt-hour meter, etc. at the front end of the distribution transformer 102, and includes a low voltage circuit breaker (ACB) at the rear end of the distribution transformer. Since power is divided into several loads through several circuit breakers (CBs) and a low voltage cable is connected to the charger, the conventional electric vehicle charger 100 has problems in that the unit price is increased and efficiency is lowered due to a plurality of low voltage, high-current power devices.

Moreover, when a power factor improving circuit is added or a reverse power conversion structure is added to the rectifier 110 to improve a power factor, there is a problem in that a structure of the charger becomes more complicated.

In addition, in order to enable reverse power conversion in the charger, a PWM ac/dc converter needs to be used, which has disadvantages of high loss and a high price.

The isolated dc/dc converter also has disadvantages of complexity, low efficiency, and high cost.

The configuration of an isolated dc/dc converter capable of reverse power conversion is more complex and costly.

On the other hand, in recent years, in a battery of the electric vehicle, a capacity thereof is getting larger, and there is a trend to increase a voltage instead of increasing a capacity of a current. Accordingly, in the conventional battery, a 380 Vdc class was a main type, but recently, an 800 Vdc class is the main type as the voltage has gradually increased. The reason for increasing the voltage of the battery is that it is advantageous to reduce the current and increase the voltage in order to not only increase efficiency of a driving inverter or a motor in the vehicle, but also to reduce heat generated by a charging cable and a charging connector during fast charging.

If the voltage of the battery goes to the 800 V class, it is efficient to increase an input voltage of the charger accordingly, but since an output voltage of the distribution transformer is used together with other loads, there is no choice but to use three-phase 220 V or three-phase 380 V as it is. This has a disadvantage that a lot of current flows through the circuit breaker or the low voltage cable at the input terminal of the charger, resulting in more loss and higher cost.

For example, when calculating the overall efficiency from the distribution line to the electric vehicle in the charger implemented with the latest technology, it is only about 90%.

Conventional Charger Efficiency=Distribution Transformer (99%)+Low Voltage Device/Cable (97%)+Rectifier (98%)+dc/dc Converter (96%)=90%

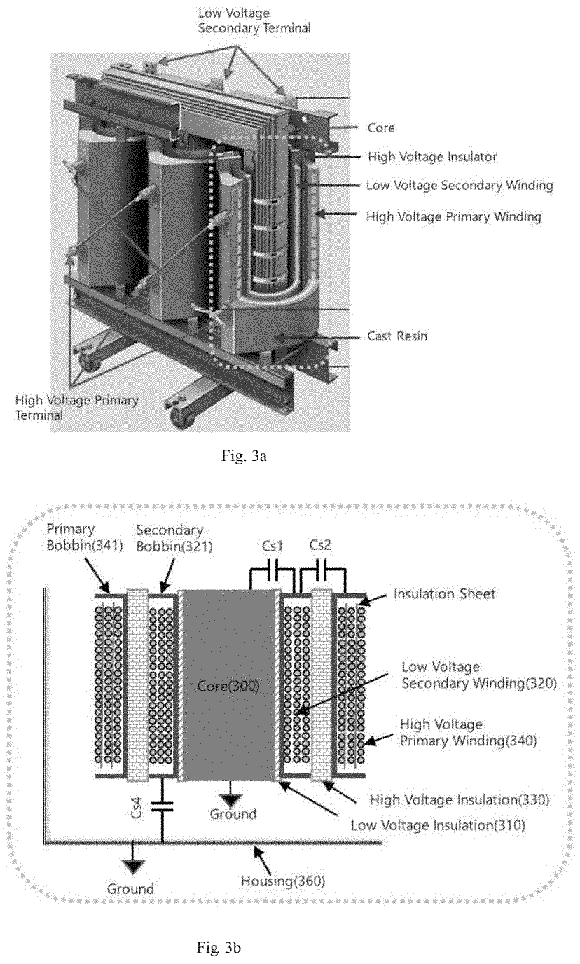

FIG. 2 illustrates a configuration diagram of a direct electric vehicle charger 200 according to the present disclosure.

In the case of the present disclosure, electrical insulation required for the charger utilizes an insulation function of the distribution transformer. Accordingly, the charger according to the present disclosure simply includes a distribution transformer 102, a diode rectifier 210, and a non-isolated dc/dc converter 220.

For example, the distribution transformer 102 has a primary winding connected to a high voltage distribution line 101 through a high voltage circuit breaker, and one or more independent secondary windings connected to a low voltage output terminal. The voltage of the distribution line is higher than 10 kV and lower than 30 kV.

A circuit breaker is connected to each output terminal of the one or more distribution transformers 102, and a low voltage cable 103 is connected to an output of each circuit breaker. Here, the low voltage cable 103 is a cable connecting the distribution transformer and the rectifier. The low voltage cable 103 has a stray capacitance (Cs5) between the cable and the surrounding earth, conductor, dielectric, or other two-dimensional cables, through which leakage current may occur. In the electric vehicle charger, the insulation between input and output is sufficiently large so that a leakage current needs to be a specific value or less. However, if the stray capacitance is large, a specification of the leakage current may not be satisfied. Therefore, in order to reduce the stray capacitance, the low voltage cable and the surrounding earth, conductor, dielectric, or other two-dimensional cables need to be installed with a maximum distance spaced apart from each other.

The charging cable 104 is a cable connecting between the non-insulated dc/dc converter and the charging connector, and there is a stray capacitance (Cs6) between the cable and the surrounding earth, conductor, or dielectric, through which leakage current may occur. Similarly here, in order to reduce the stray capacitance, the charging cable and the surrounding earth, conductor, or dielectric need to be installed with a maximum distance spaced apart from each other.

The rectifier 210 is connected to an end of each low voltage cable 103, and the non-isolated dc/dc converter 220 is connected to an output of each rectifier 210. A charging cable 104 and a charging connector 105 are connected to an output terminal of each non-isolated dc/dc converter 220.

The rectifier may be implemented as a diode rectifier, and an output current and voltage of the non-isolated dc/dc converter 220 may be controlled through a charging controller 230. Since the electric vehicle charger according to the present disclosure uses the high voltage distribution line 101 as a direct input, the electric vehicle charger according to the present disclosure will be hereinafter referred to as a direct charger.

Meanwhile, although not illustrated in FIG. 2, the electric vehicle charger may have a capacitor filter of 50 μf or less added to the output terminal of each rectifier and removing high-frequency ripples.

In addition, the electric vehicle charger may have an LC filter added between the rectifier and the non-isolated dc/dc converter.

In order to minimize the loss of the low voltage circuit breaker, the low voltage cable, and the like, it is advantageous to increase the output voltage of the distribution transformer. However, since a voltage rating of a power semiconductor device used in the rectifier and the non-isolated dc/dc converter is mainly 1200 Vdc, it is preferable to limit the output voltage of the distribution transformer to 600 V or less. In addition, in order to maximize the efficiency of the rectifier and the non-isolated dc/dc converter as the voltage of the battery of the recent electric vehicle changes to an 800 Vdc standard, it is preferable to match the voltage of the battery and the output voltage of the distribution transformer similarly. Since the voltage range of the battery of 800 Vdc is approximately 600 to 900 Vdc, it is most efficient to set the output voltage of the distribution transformer in the range of 500 V to 600 V. This is because if an AC voltage of 500 to 600 V is rectified, it becomes 675 to 810 Vdc. Even if the range of the output voltage of the distribution transformer is slightly wider, about 380 to 800 V is appropriate.

In the present embodiment, a plurality of chargers may be configured by winding several secondary windings around a large-capacity distribution transformer 102 and adding the rectifier 210 and the non-isolated dc/dc converter 220 to each output. If there is a load that requires a standard voltage of 220 V or 380 V, a separate secondary winding suitable for the load is wound and used.

The high voltage circuit breaker (VCB) is located at the front end of the distribution transformer 204 and the secondary winding is divided into several at the rear end, so that there is no need to use a large capacity low voltage circuit breaker (ACB), and since a simple circuit breaker (CB) may be used for each output terminal of the secondary winding, the number of power devices such as large capacity circuit breakers may be greatly reduced.

In addition, as a secondary output voltage of the distribution transformer 204 is increased to 500 V to 600 V, the price of the circuit breaker or the power cable may be significantly reduced and the loss thereof may also be significantly reduced.

For this reason, since the configuration of the electric vehicle charger 200 according to the present disclosure including the rectifier 210 and the non-isolated dc/dc converter 220 is much simpler than the configuration of the conventional charger 100, the cost is low and the efficiency is high.

That is, if the overall efficiency of the charger from the distribution line 101 to the electric vehicle is calculated, it is about 95% as illustrated below, and it is about 5% higher than that of the conventional charger, which may greatly help save energy.

Direct Charger Efficiency=Distribution Transformer (98.5%)+Low Voltage Device/Cable (99%)+Rectifier (99.5%)+dc/dc Converter (98%)=95%

On the other hand, the direct charger such as the electric vehicle charger of the present disclosure has an advantage of also easily performing bidirectional power conversion for vehicle-to-grid (V2G). Therefore, the electric vehicle charger 200 according to the present disclosure may be effectively used in a newly constructed electric vehicle charging station, an electric bus garage charging station, a parking lot charging station when constructing a new building, an outdoor parking lot charging station, a highway rest area charging station, and the like.

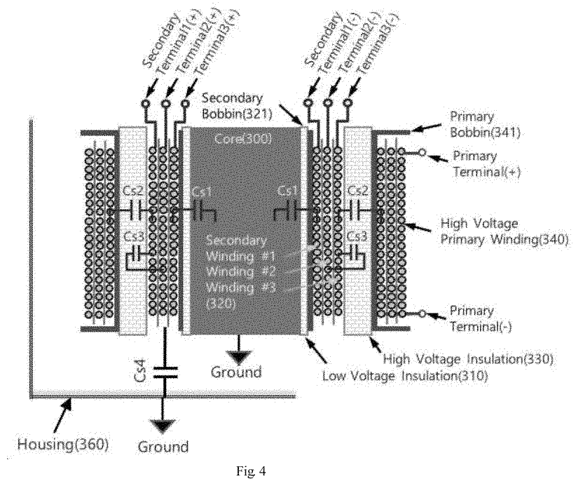

FIGS. 3a-3b illustrate configuration diagrams of a conventional distribution transformer.

Referring to FIGS. 3a-3b, the conventional distribution transformer includes a low voltage insulating layer on an outside of a core 300, a secondary winding wound around the low voltage insulating layer, a high voltage insulating layer on an outside of the secondary winding, a primary winding wound around the high voltage insulating layer, and a high voltage insulating layer on an outside of the primary winding. A terminal of the secondary winding is exposed to the top adjacent to the core, and a terminal of the primary winding is mainly exposed from the side surface.

In more detail, the conventional transformer has a thin insulating layer 310 on an outside of a grounded core 300, a secondary winding 320 on an outside of the thin insulating layer 310, a thick high voltage insulating layer 330 on an outside of the secondary winding 320, and a primary winding 340 wound around the thick high voltage insulating layer 330, centering on the grounded core 300.

In the conventional distribution transformer, since the core is grounded and the secondary winding 320 is adjacent to the core 300, a stray capacitance Cs1 is large between the core and the secondary winding 320, and a stray capacitance Cs2 with the primary winding 340 is also present. A housing 360 is also grounded, and a stray capacitance Cs4 also exists between the secondary winding 320 and the housing 360. Since a large amount of leakage current may flow through the stray capacitance when a potential of the secondary winding 320 changes rapidly, it may be difficult to meet the specifications of the charger.

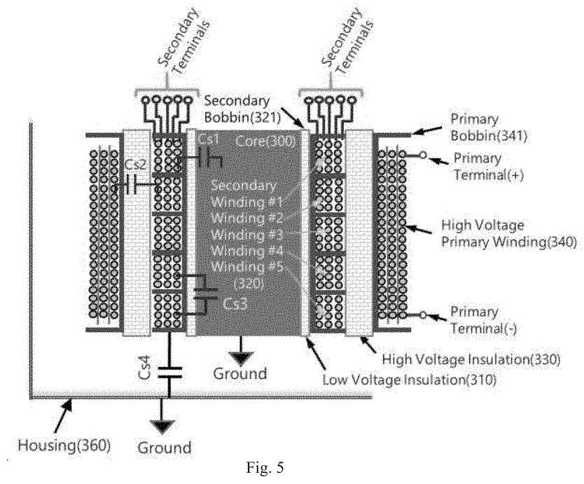

FIG. 4 illustrates a structure of a distribution transformer for a direct electric vehicle charger.

Referring to FIG. 4, a grounded core 300 is positioned at the center of the distribution transformer for direct charger. A low voltage insulating layer 310 is installed on an outside of the core 300, and secondary windings having a plurality of layers are wound around an outside of the low voltage insulating layer 310. The secondary windings wound around the outside of the low voltage insulating layer 310 may be wound one by one on the basis of an outer surface of the low voltage insulating layer 310, and an insulating layer may be positioned between the respective layers of the wound secondary windings. A terminal of each secondary winding may be exposed to the top. A high voltage insulating layer 330 may be positioned on an outside of the outermost layer of the secondary winding, and a primary winding may be wound around on an outside of the high voltage insulating layer 330. In this case, the primary windings wound around the outside of the high voltage insulating layer 330 may be wound for each layer, like the secondary windings described above, and an insulating layer may be disposed between the respective layers. In addition, a high voltage insulating layer (not illustrated in the drawings) may be additionally positioned at the outermost portion of the primary winding. The terminal of the primary winding may be exposed to the outside of the high voltage insulating layer positioned at the outermost portion of the primary winding.

The direct electric vehicle charger according to present disclosure may include a stray capacitance such that the potential of each of the one or more secondary windings 320 may freely vary. In more detail, the direct electric vehicle charger according to present disclosure may include a stray capacitance (Cs3) between the secondary windings wound in different layers, a stray capacitance (Cs1) between the secondary winding and the core, a stray capacitance (Cs2) between the secondary winding and the primary winding, and a stray capacitance Cs4 between the secondary winding and the housing 360. Each of the above-described stray capacitances is configured to be sufficiently spaced apart from each other so as to be less than or equal to a specific value. The specific value of the stray capacitance is determined by the magnitude of the leakage current. In the present disclosure, since the stray capacitance between the secondary winding and the core 300 is the largest, leakage current is highly likely to occur, and therefore, the low voltage insulating layer 310 may need to have a thickness sufficient to prevent the leakage current.

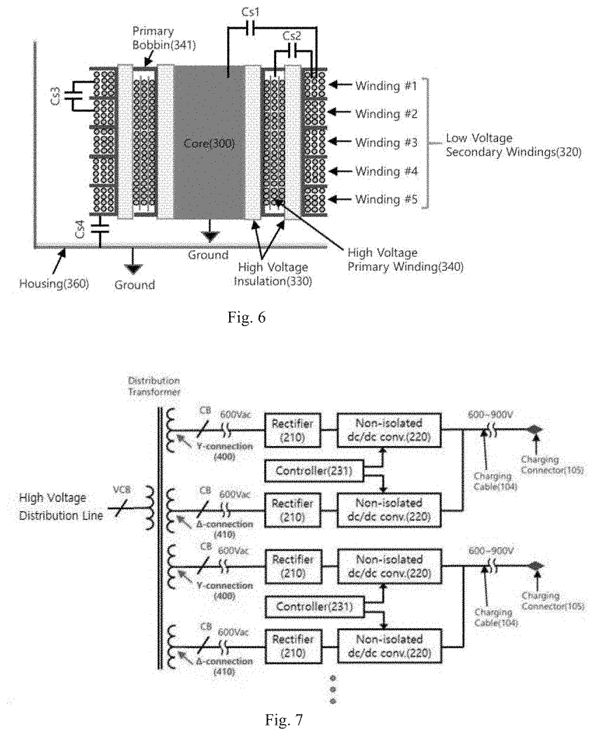

FIG. 5 illustrates another structure of the distribution transformer for the direct electric vehicle charger. As illustrated in FIG. 5, in another structure of the distribution transformer according to the present disclosure, one secondary winding may be wound around a separate bobbin 321 and a plurality of bobbins may be sandwiched one by one and stacked to configure secondary windings. However, the distribution transformer having the above-described structure has a disadvantage in that the leakage inductance between the primary winding 340 and the secondary winding 320 may increase. Even in this case, each of the one or more secondary windings 320 or the low voltage insulating layer 310 may be designed so that a stray capacitance between the transformer core 300, the primary winding 340, another secondary winding, or the housing 360 is a specific value or less.

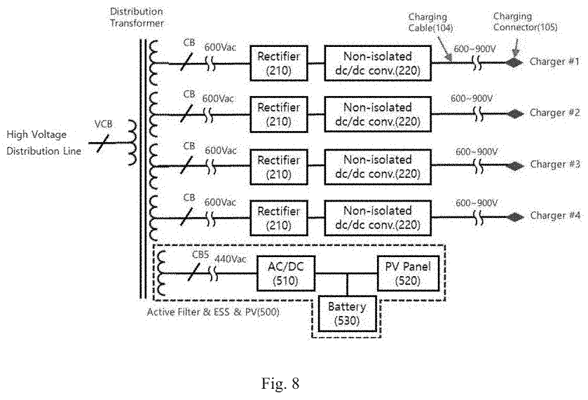

FIG. 6 illustrates still another structure of the distribution transformer for the direct electric vehicle charger. Still another structure of the distribution transformer illustrated in FIG. 6 has a configuration in which the primary winding 340 is wound on an inside close to the core 300, and the secondary winding 320 is wound on an outside of the primary winding 340. In this case, since the high voltage insulating layer 330 needs to be placed between the core 300 and the primary winding 340 and the high voltage insulating layer also needs to be placed on the outside of the primary winding, a volume of the distribution transformer may increase. However, when the number of secondary windings 320 is large because the secondary windings 320 are wound on the outermost portion, still another structure of the distribution transformer may have advantages of being able to easily expose the terminals of the secondary windings 320, and minimizing stray capacitances between the secondary winding 320 and the core 300, and between a specific secondary winding 320 and the primary winding 340.

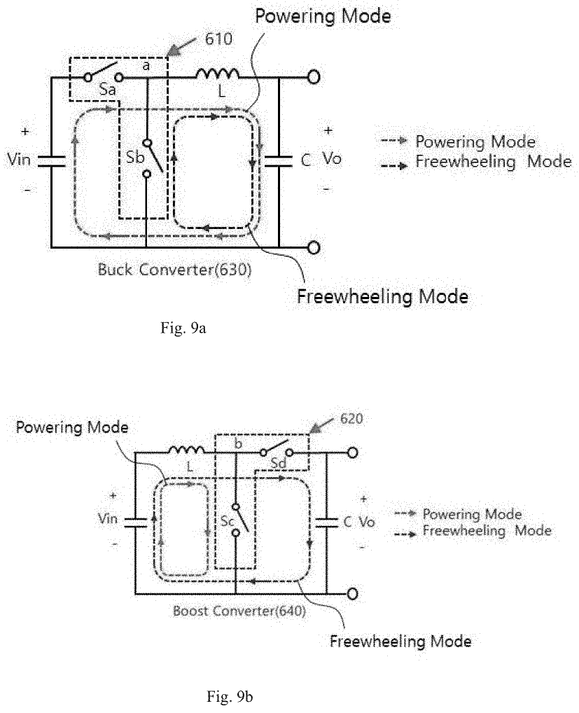

FIG. 7 is a configuration diagram of a secondary winding of a distribution transformer for 12-pulse rectification in the direct charger. In the distribution transformer for direct charger illustrated in FIG. 7, an even number of secondary windings are wound, and the Y-connections 400 and Δ-connections 410 having the same output voltage are wound in half and half, the Y-connection and the Δ-connection are pulled out one by one to connect the rectifier 210 and the non-isolated dc/dc converter 220 connected in series with each other to each of the pulled Y-connection and Δ-connection, and the output terminals are connected in parallel to each other. Here, the charging controller 231 configures a 12-pulse rectifier by equally controlling the currents of the two non-isolated dc/dc converters 220 to improve an input power factor.

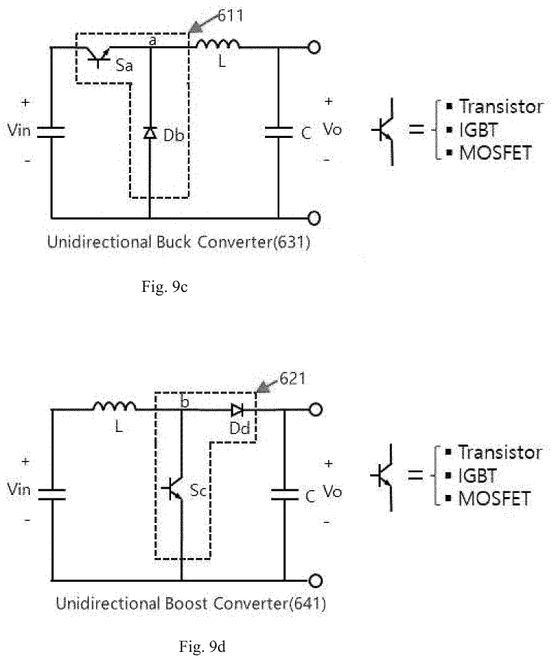

FIG. 8 illustrates an active filter and an energy storage function implemented by winding a separate additional secondary winding in addition to the secondary windings for the charger, attaching a 3-phase AC/DC converter 510 to an output terminal of the separate additional secondary winding, and connecting a battery 530 to a dc-terminal in the distribution transformer for the direction charger. In addition, a photovoltaic power generation function may be implemented by additionally attaching a photovoltaic power generation device 520 to the dc-terminal in the distribution transformer for the direct charger.

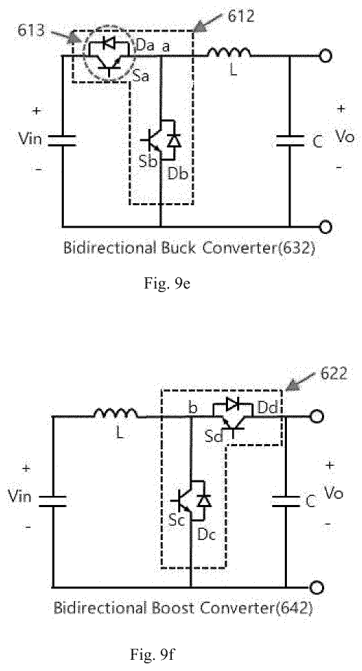

FIGS. 9a to 9f illustrate the configuration and operating principle of a buck converter 630 and a booster converter 640, which are representative non-isolated dc/dc converters.

As illustrated in FIG. 9a, the buck converter 630 is configured so that a buck switch 610 configured by connecting two switches in series is connected to both ends of an input voltage source, one end of an inductor L is connected to a middle point of the buck switch, the other end of the inductor L is connected to a (+) terminal of an output capacitor, and a (−) terminal of the input voltage source and a (−) terminal of the output capacitor are connected to each other. In the buck switch, the two switches are alternately turned on, and when an upper switch Sa is turned on, a voltage equal to Vin-Vo is applied across the inductor L, and a current in the inductor increases, and when a lower switch Sb is turned on, a voltage of −Vo is applied across the inductor L, and the current in the inductor decreases. A mode in which the current in the inductor increases is called a powering mode, and a section in which the current in the inductor decreases is called a freewheeling mode. An output voltage of the buck converter is linearly changed according to a ratio (d.buck) of the powering mode and the freewheeling mode. This may be expressed as Equation as follows.

Vo=d.buck*Vin Equation 1

As illustrated in FIG. 9b, the booster converter (640) is configured so that a booster switch 620 configured by connecting two switches in series is connected to both ends of an output capacitor, one end of an inductor L is connected to a middle point of the booster switch, the other end of the inductor L is connected to a (+) terminal of an input voltage source, and a (−) terminal of the input voltage source and a (−) terminal of the output capacitor are connected to each other. In the booster switch, the two switches are alternately turned on, and when a lower switch Sc is turned on, a voltage equal to Vin is applied across the inductor L, and a current in the inductor increases, and when an upper switch Sd is turned on, a voltage equal to Vin-Vo is applied across the inductor L, and the current in the inductor decreases. A mode in which the current in the inductor increases is called a powering mode, and a section in which the current in the inductor decreases is called a freewheeling mode. An output voltage of the booster converter is determined by the following equation by a ratio (d.boost) of the powering mode and the freewheeling mode.

Vo=Vin/(1−d.boost) Equation 2

FIGS. 9c to 9d illustrate a structure of a switch in which forward power conversion is performed in the buck converter or the booster converter. A unidirectional buck switch 611 is configured by connecting a forward active switch Sa and a reverse diode Db in series, and a unidirectional booster switch 621 is configured by connecting a reverse diode Dd and a forward active switch Sc in series.

FIGS. 9e to 9f illustrate a structure of a switch in which bidirectional power conversion is performed in the buck converter or the booster converter. A bidirectional buck switch 612 is configured by connecting two switches 1 613 including an active switch Sa and an anti-parallel diode Da in series, and a booster switch 622 is also configured by connecting the two switches 1 613 in series in the same manner. A device that may be used as the active switch in the buck switch or the booster switch may be a transistor, an IGBT, a MOSFET, or the like.

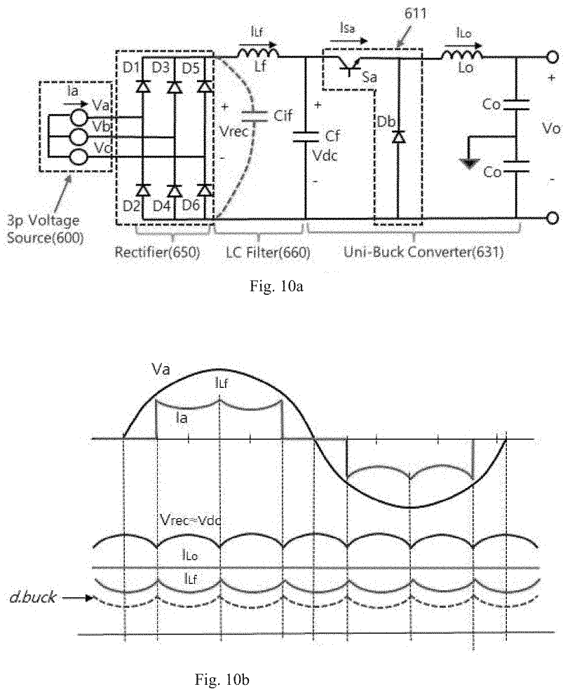

FIG. 10a illustrates a configuration in which a three-phase diode rectifier 650 and an LC filter 660 are connected to a three-phase input voltage source 600, that is, an output voltage of the distribution transformer, and a unidirectional buck converter 631 is connected to a rear end thereof, as an embodiment of implementing the rectifier 650 and the non-insulated dc/dc converter 220 in the direct charger.

The rectifier 650 is a rectifier that simply rectifies three-phase power without switching. It is difficult to use a PWM converter that performs high-frequency switching. This is because a large amount of leakage current may occur because the potential of the secondary winding of the transformer greatly changes instantaneously by high-frequency switching. In general, in an electric vehicle charger, an output terminal connected to the electric vehicle is completely insulated from an input terminal, two output terminal capacitors are formed in series, and an intermediate voltage is set to ground. For this reason, in the configuration of the three-phase diode rectifier and the non-isolated dc/dc converter, since one phase of the secondary winding and the (−) terminal of the rectifier and the (−) terminal of the non-isolated dc/dc converter are all connected, the potential of the secondary winding of the distribution transformer does not change instantaneously and changes gradually according to a ripple of 300 Hz or 360 Hz of the rectified voltage. Therefore, a large amount of leakage current does not occur.

FIG. 10b illustrates an input voltage Va and an input current Ia of the diode rectifier 650 according to the present disclosure, an output voltage of the diode rectifier, a current of the inductor of the LC filter 660, and a waveform of a duty ratio of the buck converter 631 of the rear end.

In a general case, the LC filter at the output terminal of the diode rectifier is configured such that a cutoff frequency fc of the LC filter is 1/10 or less of the ripple frequency (6 times an input power frequency) of the output voltage of the diode rectifier 650.

The cutoff frequency of the LC filter is expressed as Equation as follows.

$$fc = \frac{1}{2 π \sqrt{LfCf}} \qquad Equation 3$$

On the other hand, even if the cutoff frequency of the LC filter to make the ripple voltage of the filter capacitor voltage within 10% of the filter capacitor voltage is only about fc=1/20*(the frequency of the rectifier output ripple voltage), since the frequency of the input power is 50 Hz or 60 Hz, the LC filter needs to be an inductor of approximately 5 mH and a capacitor of 5 mF. From this, it may be seen that the size and weight of the LC filter are extremely large.

The characteristic of the LC filter according to the present disclosure is to filter only the switching ripple of the buck converter 631 of the rear end without filtering the ripple of the output voltage (6 times the frequency of the input power frequency) of the diode rectifier 650 at all. Accordingly, the output capacitor voltage Vdc of the LC filter almost follows the output voltage Vrec of the diode rectifier 650.

When the output voltage of the buck converter 631 is constantly controlled, that is, in order to supply a constant power, the duty ratio (d.buck) of the buck converter needs to be controlled in an opposite direction to the ripple of the dc-link capacitor voltage (Vdc), and the current of the inductor of the LC filter has a ripple opposite to the voltage ripple of the diode rectifier 650. When the corresponding ripple flows to the input power, it becomes a slightly deformed 6-pulse waveform as illustrated in FIG. 10b, but this does not significantly lower an input power factor from 0.9.

For example, when the switching frequency of the buck converter 631 is 80 kHz and the cutoff frequency of the LC filter is designed to be 1/10 of the switching frequency of the buck converter, fc=8 kHz. In this case, the values of inductor and capacitor values are 20 uH and 20 μF, respectively. In this case, it may be seen that the LC filter according to the present disclosure has a capacity of about 0.4% compared to the conventional LC filter, and there is a remarkable improvement in the size, weight, and cost of the LC filter. In addition, according to the present disclosure, the dynamics for control is greatly improved due to the high cutoff frequency of the LC filter. It is appropriate to set the cutoff frequency of the LC filter in the range of 1/30 to ⅓ of the switching frequency of the non-isolated dc/dc converter of the rear end to achieve the above object.

On the other hand, since the size of the LC filter is greatly reduced, the output voltage of the LC filter may significantly increase when a surge occurs at the three-phase input terminal. To prevent such a problem, an over-voltage clamp circuit in which a clamp diode and a clamp capacitor are connected in series may be added to the output terminal of the rectifier. In this case, normally, since the clamp capacitor is charged higher than a maximum value of the output terminal of the rectifier, the clamp diode is always turned off, and when a surge occurs at the input terminal, the clamp diode is turned on, and the output voltage of the rectifier may be clamped to the voltage of the clamp capacitor to avoid over-voltage. In an embodiment, it is possible to connect a discharge resistor in parallel with the clamp diode so that energy is not continuously accumulated in the clamp capacitor.

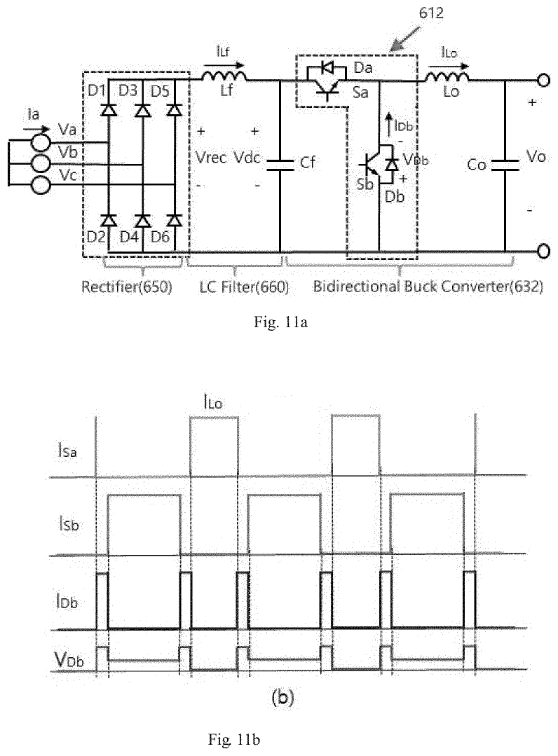

FIG. 11a illustrates a buck converter 632 capable of bidirectional power conversion by applying a bidirectional buck switch instead of a unidirectional buck switch in the unidirectional buck converter 631.

FIG. 11b illustrates a method of reducing a conduction voltage and conduction loss of the diode by turning on an active switch connected in anti-parallel with the diode to turn the current flowing through the diode into the active switch when the diode is conducted in configuration of the bidirectional buck converter 632.

However, when an overlap period in which two active switches are turned on at the same time during switching occurs, the input voltage may be short-circuited. Therefore, in the present disclosure, it is possible to give a certain dead time in which both switches are turned off when the two active switches are alternately turned on and off. In this case, the active switch may be a type of MOSFET with a function of flowing current in a reverse direction. For this purpose, it is a bidirectional buck converter, but it is also widely used for unidirectional power conversion.

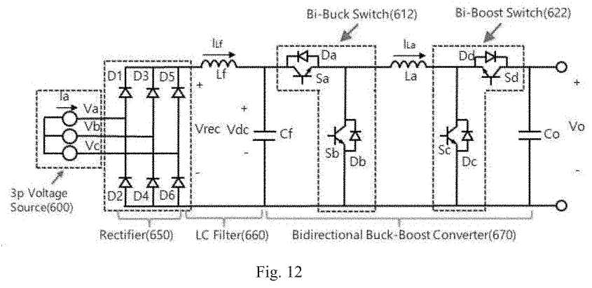

FIG. 12 illustrates a configuration of a bidirectional buck-boost converter configured by adding bidirectional boost converters to an output terminal of the bidirectional buck converter, and sharing an inductor La with each other. Because the range of fluctuation of the battery voltage to be charged is wide, in the case of using only the buck converter, a high input voltage is required and the current ripple of the inductor La increases and the efficiency decreases in the region where the voltage of the battery is low, but in the case of the buck-boost converter, if the input voltage is boosted or reduced by setting the input voltage in the middle of the range of fluctuation of the voltage of the battery, charging may be most efficiently performed.

In the bidirectional buck-boost converter illustrated in FIG. 12, it is desirable to operate only the buck converter when the input voltage is higher than the voltage of the battery, operate only the booster converter when the input voltage is lower than the output voltage, and operate both the buck-boost converter when a difference between the input voltage and the voltage of the battery is within a certain range. However, even when only the booster converter operates, the charger and the load may be protected by turning off the buck converter in case of emergency.

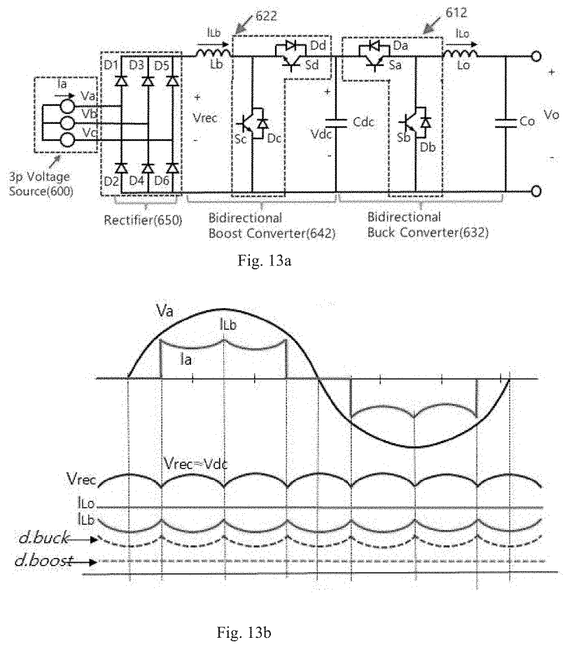

FIGS. 13a-13c illustrate a configuration, and operation waveforms, and of a bidirectional booster-buck converter in which a three-phase diode rectifier 650 is connected to a three-phase input voltage source, and a bidirectional booster converter 642 and a bidirectional buck converter 632 are sequentially connected to a rear end thereof, as an embodiment of implementing the rectifier 650 and the non-insulated dc/dc converter in the direct charger. In FIG. 13a, if the switch structure is changed to a unidirectional booster switch and a unidirectional buck switch, a unidirectional booster-buck converter may be configured. The booster-buck converter may have two control methods in order to minimize the sizes of a booster inductor Lb and a dc-link capacitor Cdc.

As illustrated in FIG. 13b, if the duty ratio (d.boost) of the booster converter is fixed to a certain duty ratio to filter the output voltage of the rectifier, the dc-link voltage Vdc almost follows the output voltage Vrec of the rectifier, the duty ratio (d.buck) of the buck converter at the rear end and the booster inductor Lb generate a ripple in a direction opposite to the ripple of the output voltage of the rectifier, and a final output voltage may be constantly controlled. When the voltage of the battery is lower than the output voltage of the rectifier, the booster switch may not be operated, and in this case, a rectifier-LC filter-buck converter structure of FIG. 10a is obtained, and the operation waveform is the same as that of FIG. 10b.

In FIG. 13c, in order to filter the output voltage of the rectifier, when the output voltage of the booster converter, that is, the dc-link voltage, is constantly controlled, the duty ratio (d.boost) of the booster converter and the current of the booster inductor Lb have a ripple in the direction opposite to a waveform of the output voltage Vrec of the rectifier, and when the dc-link voltage is constantly controlled, the duty ratio (d.buck) of the buck converter is also constant in order to control the final output voltage constant.

In order to constantly control the output voltage of the booster converter 642, a dc-link capacitor having a large capacity to filter the ripple of the output voltage of the rectifier corresponding to 6 times an input ac voltage needs to be used.

In an embodiment, it is possible to set the three-phase input voltage to the middle of the range of fluctuation of the voltage of the battery to be charged and operate only the buck converter when the voltage of the battery is lower than the voltage Vrec of the rectifier, operate only the booster converter when the voltage of the battery is higher than the voltage Vrec of the rectifier, and operate both the booster converter and the buck converter when the difference between the voltage of the battery and the voltage Vrec of the rectifier is within a certain range.

As another control method, in controlling the duty ratio between the booster converter and the buck converter, it is possible to control the current ripple of the booster inductor Lb and the buck inductor Lo to be minimized Even in this case, similar to the bidirectional buck-boost converter of FIG. 12, the conduction loss of the diode may be significantly reduced by turning on the anti-parallel switch when the diode conducts while performing the unidirectional power conversion.

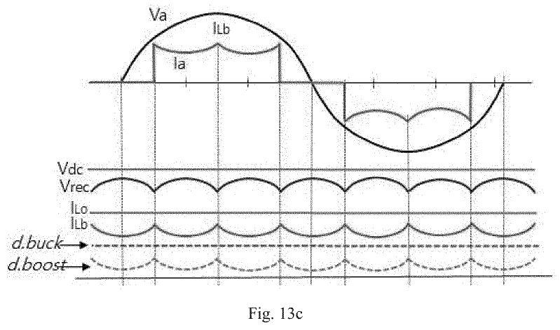

FIGS. 14a-14b illustrate a first auxiliary circuit 700 for zero-voltage switching of the buck-boost converter and an operation waveform thereof. The zero-switching first auxiliary circuit 700 has a configuration in which a resonant inductor Lr and a switch Sr are connected in series so that both ends thereof are connected between a middle point of the buck switch 611 and a middle point of the booster switch 621, and two clamp diodes are respectively connected between the point where the resonant inductor Lr and the switch Sr are connected and both ends of the buck switch. When the resonant inductor Lr is connected to the booster switch and the switch Sr is connected to the buck switch, the two diodes are connected to both ends of the booster switch.

As illustrated in FIG. 14b, the active switches Sa and Sc of the buck switch 611 and the booster switch 621 are synchronized and turned on at the same time, and according to the duty ratio (d.buck) of the buck converter and the duty ratio (d.boost) of the booster converter, Sa and Sc are turned off and Db and Dd are turned on. When Sa and Sc are turned off, zero-voltage switching is performed because there is capacitance at both ends of the switch, but when the active switches Sa and Sc are turned on while Db and Dd are conducting, hard switching is performed. The first auxiliary circuit increases a resonance current by turning on an auxiliary switch Sr in advance so that Sa and Sc may perform the zero-voltage switching. When the resonance current becomes larger than the La current, Db and Dd are turned off, and Da and Dc are turned on while the capacitance and the resonance inductor Lr at both ends of the switch resonate. In this case, when Sa and Sc are turned on, the zero-voltage switching is performed. When Sa and Sc are turned on, the current of the resonant inductor decreases linearly to zero. When the current of the resonant inductor becomes zero, the operation of the auxiliary circuit is completed by turning off Sr.

The conventional buck-boost converters each require a zero-voltage switching auxiliary circuit, but in the present disclosure, the zero-voltage switching is possible for both the buck converter and the booster converter with one auxiliary circuit.

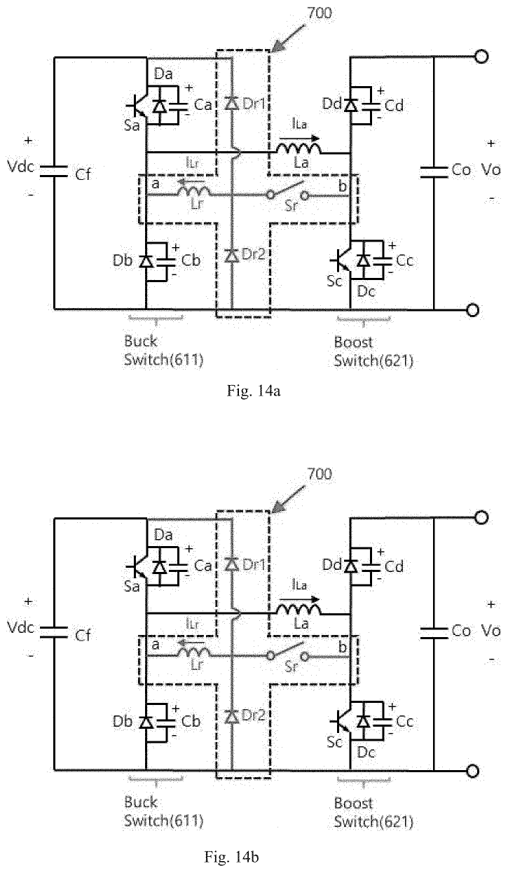

FIG. 15 illustrates a configuration of an auxiliary circuit 710 when power conversion is performed in one direction. A configuration of an actual switch is illustrated instead of an ideal switch of the auxiliary circuit. The ideal switch may be configured by connecting a diode in series with the first switch. A direction of the auxiliary switch is a direction in which current flows from the booster switch to the buck switch.

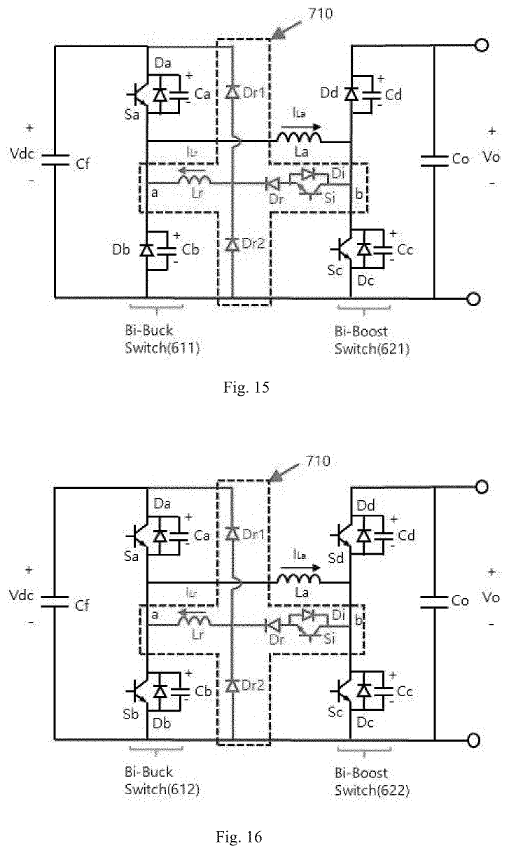

FIG. 16 illustrates a zero-voltage switching auxiliary circuit 710 when the unidirectional buck-boost converter of FIG. 15 is configured with a bidirectional buck switch and a bidirectional booster switch instead of the unidirectional buck switch and the unidirectional booster switch and unidirectional power conversion is performed. Even in the case of a bidirectional switch, if the power conversion is unidirectional, the configuration of the zero-voltage switching auxiliary circuit is the same. Even when Db and Dd are turned on when the unidirectional power conversion is performed, conduction loss between Db and Dd may be reduced by turning on Sb and Sd. In a general case, at the end of the switching cycle of the buck-boost converter, in order to prevent the buck switch or booster switch from being short-circuited due to two active switches being turned on at the same time, a method is used in which Sb and Sd are turned off for a certain dead time so that Db and Dd are turned on, and then Sa and Sc are turned on. However, in the case of zero-voltage switching, the switching method is different. That is, in order to turn on Sa and Sc to zero voltage according to the switching period of the buck-boost converter, the current of the resonant inductor increases by turning on an auxiliary switch Si before the switching period, and Sb and Sd are not turned off and continuously turned on at the end of the switching period. Then, the current of the resonant inductor may be made larger than the current of the inductor La, and if Sb and Sd are turned off after the current of the resonant inductor increases by a certain amount, Da and Dc are turned on for a longer time due to resonance, such that a time width for turning on Sa and Sc to zero voltage is longer, thereby making it possible to perform the zero-voltage switching with a more margin. On the other hand, in the case of the unidirectional buck-boost converter of FIG. 15, since the time for performing the zero-voltage switching is just set, complete zero-voltage switching may not be performed when the switching time deviates even a little from that time.

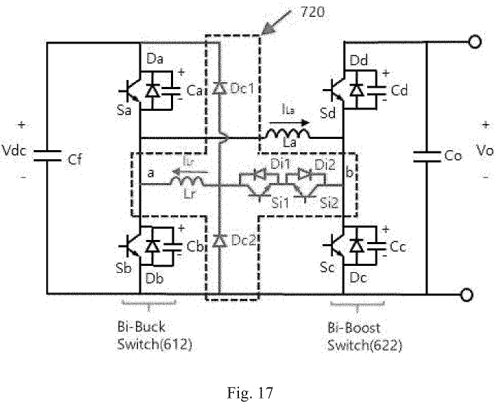

FIG. 17 illustrates a configuration diagram of a third auxiliary circuit 720 for zero-voltage switching when bidirectional power conversion is performed in a bidirectional buck-boost converter. The auxiliary switch of the auxiliary circuit is configured as a bidirectional switch so that bidirectional current may flow and bidirectional voltage may also be applied.

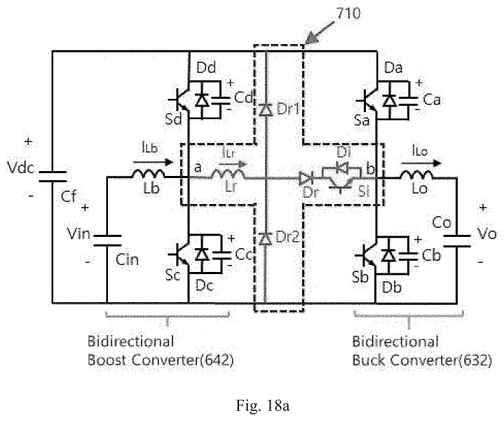

FIGS. 18a-18b illustrate a configuration diagram and an operation waveform of an auxiliary circuit 2 for zero-voltage switching when a bidirectional booster converter and a bidirectional buck converter are sequentially connected to form a bidirectional booster-buck converter. Unlike the buck-boost converter of FIG. 15, in the case of the booster-buck converter, since the currents flowing through the booster switch and the buck switch are different from each other, the auxiliary circuit 2 may not be used in the case of the booster-buck converter configured with the unidirectional booster switch and the unidirectional buck switch. In the case of the booster-buck converter, zero-voltage switching is possible even if different currents flow only when the bidirectional booster switch and the bidirectional buck switch are used. Similarly for the booster-buck converter, the switching periods of the booster switch and the buck switch need to be synchronized, and Sd and Sb are tuned on until one switching period ends. Before one switching period ends, the auxiliary switch Si is turned on to increase the current of the resonant inductor, and when the current of the resonant inductor becomes larger than a larger current between the current of the booster inductor Lb and the current of the buck inductor Lo, Sd and Sb are turned off. When Sd and Sb are turned off, the resonant inductor and the capacitor at both ends of the switch resonate, so that Da and Dc are turned on and Sa and Sc may be turned on with zero-voltage. When the current of the resonant inductor is increased until it becomes a current that is partially larger than the larger current between the current of the booster inductor Lb and the current of the buck inductor Lo, the time margin for zero-voltage switching of Sa and Sc is increased.

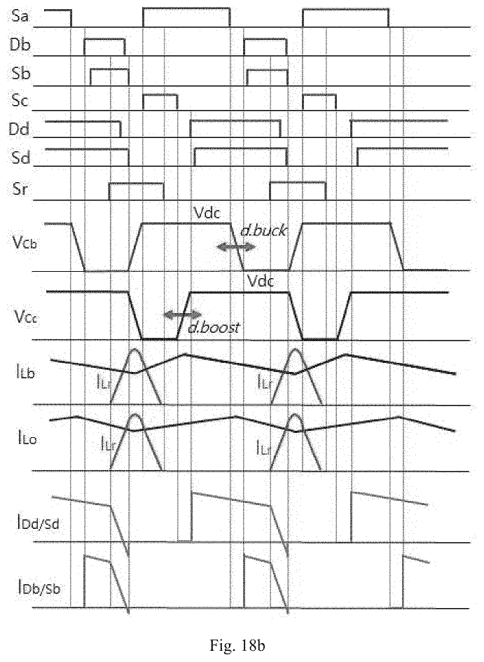

FIG. 19 illustrates a configuration diagram of a third auxiliary circuit 720 for zero-voltage switching when bidirectional power conversion is performed in a bidirectional booster-buck converter. The auxiliary switch of the auxiliary circuit is configured as a bidirectional switch so that bidirectional current may flow and bidirectional voltage may also be applied.

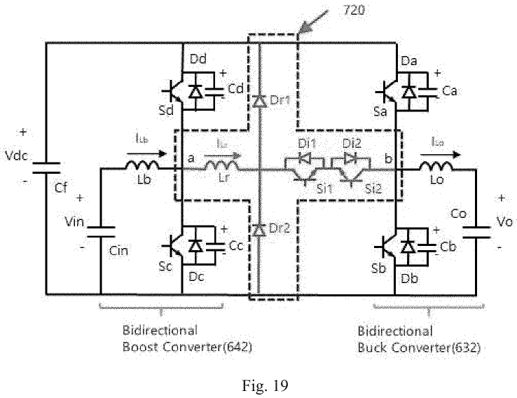

FIGS. 20a-20b illustrates a configuration and an operation principle of a rectifier 800 capable of performing bidirectional power conversion for charging and discharging. The rectifier 800 is configured by attaching an active switch in the reverse direction to both ends of each diode in the three-phase diode rectifier 650.

FIG. 20b illustrates the operation principle of the bidirectional rectifier 800. During discharging, the rectifier 800 regenerates power to the distribution system by turning on the active switch above at the corresponding switch pole connected to the input power of each phase when a voltage waveform of each input phase is from 30 to 150 degrees, and turning on the active switch below at the corresponding switch pole connected to the input power of each phase when the voltage waveform of each input phase is from 210 to 330 degrees.

It may be seen that a shape of the input phase current is the same as the shape of the current during charging and a polarity thereof is reversed.

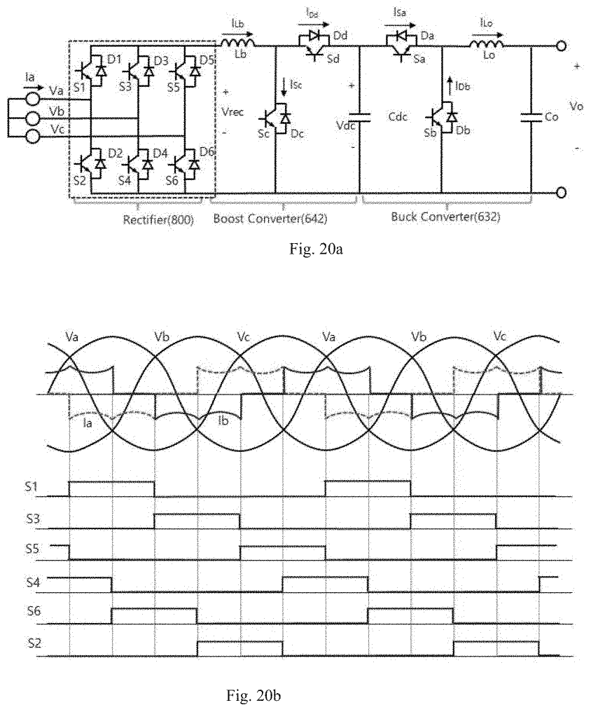

Referring to FIG. 21, when the switching time overlaps during discharge in the rectifier 800, an input phase-to-phase voltage is short-circuited, so that a large pulse current may flow as illustrated in FIG. 21. In order to solve such as problem, it is possible to solve such a problem by setting a certain dead time between an active switch that is turned off and an active switch that is turned on. However, during the dead time, there is no place for the current of the inductor Lb connected to the output terminal of the rectifier to flow, and the voltage across the rectifier 800 rises high, causing a problem in that the element is damaged.

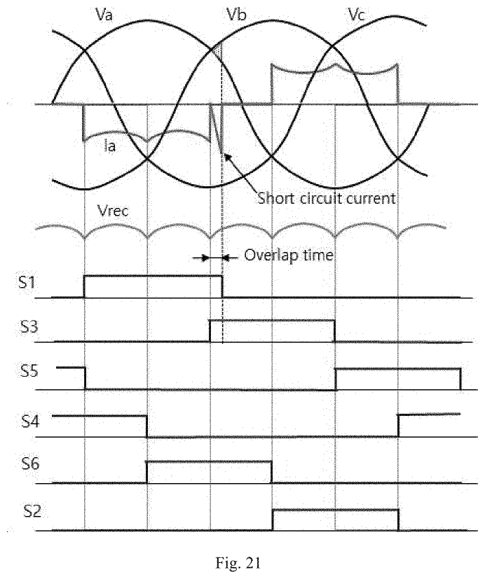

Referring to FIGS. 22a-22b, in order to solve the problem described above, a clamp circuit including a diode Dc1 and a series capacitor Cc1 is connected between the (+) and (−) terminals of a rectifying terminal, when the voltage of the rectifying terminal increases, the diode Dc1 is turned on and the voltage of the rectifying terminal is clamped by the voltage of the capacitor Cc1, and clamp energy accumulated in the clamp capacitor may be discharged through a discharge resistor Rc1.

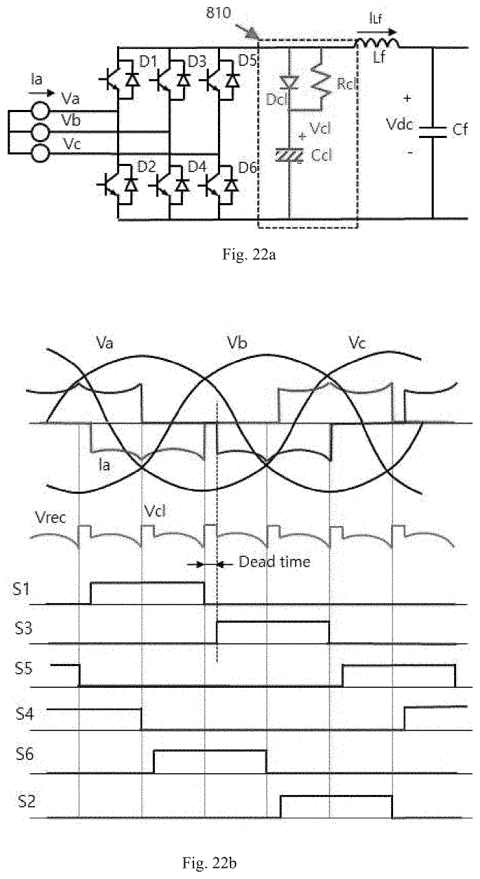

FIG. 23 illustrates that the active switch Sc1 is connected in anti-parallel with the diode instead of the discharge resistor Rc1, the diode is turned on when the voltage of the rectifying terminal is increased, the voltage of the rectifying terminal is clamped by the voltage of the clamp, and the clamp energy accumulated in the clamp capacitor may be discharged so that the voltage of the capacitor is constantly maintained by turning on the active switch when the clamp is finished and the diode is turned on. In this case, there is an advantage in that a loss due to the discharge resistor may be reduced.

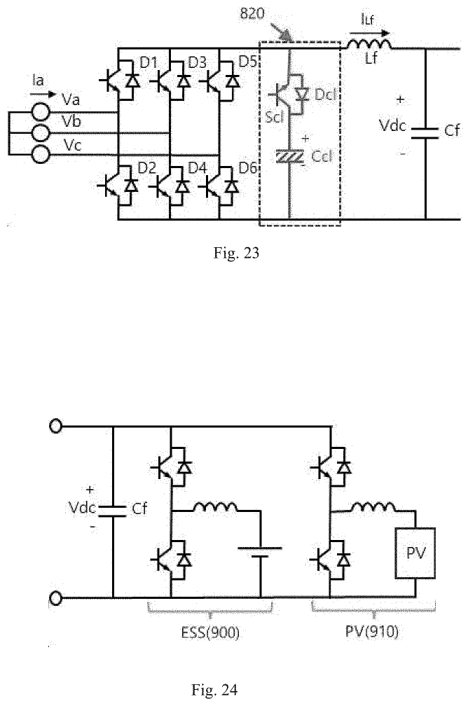

FIG. 24 illustrates an implementation example of an energy storage system 900 that stores or discharges energy by connecting a directional buck switch to both ends of the output terminal capacitor of the rectifier, connecting one end of the inductor 920 to a middle point therebetween, and connecting a battery 910 between the other end of the inductor and a (−) terminal of the output terminal capacitor. In addition, it is a configuration that enables photovoltaic power generation by further connecting one bidirectional buck switch and one inductor, and connecting a photovoltaic panel at both ends of the inductor and the output terminal capacitor Cf.

The electric vehicle charger according to an embodiment of the present disclosure may dramatically reduce the cost and maximize the efficiency by using the distribution transformer, the simple diode rectifier, and the non-isolated dc/dc converter.

In addition, the electric vehicle charger according to an embodiment of the present disclosure may also implement the regenerative charging function for V2G with high efficiency.

Hereinabove, while the present disclosure has been described and shown with reference to the embodiments for illustrating the principle of the present disclosure, the present disclosure is not limited to the shown and described configurations and actions. It will be understood by those skilled in the art that the present disclosure may be embodied in other specific forms without departing from the spirit or essential characteristics thereof. Therefore, it is to be understood that the embodiments described hereinabove are illustrative rather than being restrictive in all aspects.

### DETAILED DESCRIPTION OF MAIN ELEMENTS

100: conventional electric vehicle charger 101: distribution line
102: distribution transformer
103: low voltage cable 104: charging cable
105: charging connector
110: rectifier 120: insulated dc/dc converter
200: direct charger 210: rectifier
220: non-insulated dc/dc converter 230, 231: charging controller
300: core 310: low voltage insulating layer
320: low voltage secondary winding
321: secondary winding bobbin 330: high voltage insulating layer
340: high voltage primary winding
341: primary winding bobbin Cs1: stray capacitance between core and secondary winding
Cs2: stray capacitance between secondary winding and primary winding
Cs3: stray capacitance between secondary winding and secondary winding
Cs4: stray capacitance between secondary winding and housing
Cs5: stray capacitance between low voltage distribution line and earth or adjacent conductor
Cs6: stray capacitance between charging cable and earth or adjacent conductor
360: housing
400: Y-connection 410: Δ-connection
500: coupled device of active filter-energy storage system-photovoltaic panel
510: AC/DC converter 520: photovoltaic panel
530: battery 600: three-phase input voltage source
610: buck switch 620: booster switch
611: unidirectional buck switch 621: unidirectional booster switch
612: bidirectional buck switch 622: bidirectional booster switch
630: buck converter 640: booster converter
631: unidirectional buck converter 641: unidirectional booster converter
632: bidirectional buck switch 642: bidirectional booster converter
613: first switch
650: rectifier, three-phase diode rectifier Cif: rectifier filter capacitor
660: LC filter Lf: filter inductor
Cf: filter capacitor
Sa: active switch Db: diode Lo: buck inductor
Co: output filter capacitor 670: bidirectional booster converter
La: buck-booster inductor
680: bidirectional booster converter Sc: active switch Dd: diode
Lb: booster inductor Cdc: dc-link capacitor
700: first zero-voltage switching auxiliary circuit 710: second zero-voltage switching auxiliary circuit
720: third zero-voltage switching auxiliary circuit
800: rectifier for energy regeneration 810: first passive clamp circuit
820: second active clamp circuit
900: energy storage system 910: photovoltaic power generator

1. A direct electric vehicle charger for charging an electric vehicle, the direct electric vehicle charger comprising:
a distribution transformer having a primary winding connected to a high voltage distribution line and one or more independent secondary windings connected to a low voltage output terminal;
a circuit breaker connected to each output terminal of the distribution transformer;
a low voltage cable connected to an output of each circuit breaker;
a rectifier connected to an end of each low voltage cable;
a non-isolated DC/DC converter connected to an output of each rectifier;
a charging cable and a charging connector connected to an output terminal of each non-isolated DC/DC converter; and
a charge controller that controls the output current and voltage of the non-isolated DC/DC converter.

2. The direct electric vehicle charger of claim 1, wherein the distribution transformer is connected to the high voltage distribution line through a high voltage circuit breaker (VCB).

3. The direct electric vehicle charger of claim 1, wherein the high voltage distribution line has a voltage higher than 3 kV and lower than 30 kV.

4. The direct electric vehicle charger of claim 1, wherein the distribution transformer has an output voltage higher than 380 V and lower than 800 V.

5. The direct electric vehicle charger of claim 1, wherein the secondary windings of the distribution transformer are disposed to be spaced apart from each other so that the stray capacitance between a transformer core, the primary winding, other secondary windings, or an enclosure of the transformer is a specific value or less.

6. The direct electric vehicle charger of claim 2, wherein the distribution transformer has a configuration in which a low voltage insulating layer is placed on an outside of the core, one or more secondary windings are wound on an outside of the low voltage insulating layer, a high voltage insulating layer is placed on an outside of the secondary winding, and the primary winding is wound on an outside of the high voltage insulating layer, and
thicknesses of the low voltage insulating layer and the high voltage insulating layer are determined by each required insulating voltage and a limiting stray capacitance between the secondary winding and the core, and between the secondary winding and the primary winding, respectively.

7. The direct electric vehicle charger of claim 1, wherein the distribution transformer has the secondary windings of which half is Y-connection and half is Δ-connection, configures the same rectifier and non-insulated dc/dc converter at one output of the Y-connection and one output of the Δ-connection, configures one charger by connecting two final outputs in parallel, and performs 12-pulse rectification by equally controlling output currents of two non-isolated dc/dc converters.

8. The direct electric vehicle charger of claim 1, wherein the distribution transformer adds an active power filter or an energy storage system (ESS) function to one of the secondary windings.

9. The direct electric vehicle charger of claim 1, wherein the distribution transformer has one of the secondary windings wound with a standard voltage and uses the one secondary winding for a general charger or general load.

10. The direct electric vehicle charger of claim 1, wherein the low voltage cables, which are cables connecting the distribution transformer and the rectifier, are disposed to be spaced apart so that a stray capacitance between the cable and the surrounding earth or adjacent conductor, dielectric, or other secondary winding cable is a specific value or less.

11. The direct electric vehicle charger of claim 1, wherein the charging cables, which are cables connecting the non-insulated dc/dc converter and the charging connector, are disposed to be spaced apart so that a stray capacitance between the cable and the surrounding earth or adjacent conductor, dielectric, or other secondary winding cable is a specific value or less.

12. The direct electric vehicle charger of claim 1, wherein the rectifier is a diode rectifier for rectifying a three-phase power without switching.

13. The direct electric vehicle charger of claim 1, wherein the rectifier is an energy regenerative rectifier, and has an active switch attached to both ends of each diode of a three-phase diode rectifier in a reverse direction, and
the active switch does not switch and is turned on and off in a direction in which a maximum voltage always appears at an output terminal of the rectifier like the diode.

14. The direct electric vehicle charger of claim 12, wherein the rectifier has a capacitor filter of 50 μF or less added to both ends of an output thereof and removing high-frequency ripples.

15. The direct electric vehicle charger of claim 13, wherein the rectifier has a capacitor filter of 50 μF or less added to both ends of an output thereof and removing high-frequency ripples.

16. The direct electric vehicle charger of claim 1, wherein an LC filter is added between the rectifier and the non-insulated dc/dc converter.

17. The direct electric vehicle charger of claim 16, wherein the LC filter has a cut-off frequency in the range of 1/30 to ⅓ of a switching frequency of the non-isolated dc/dc converter connected to a rear end thereof.

18. The direct electric vehicle charger of claim 1, wherein the rectifier has a clamp circuit in which a diode and a capacitor are connected in series connected between a (+) terminal and a (−) terminal of an output terminal of the rectifier to prevent an output voltage of the rectifier from rising rapidly when a surge voltage is applied to an input terminal, and the diode is turned on when a rectifying terminal voltage rises and the rectifying terminal voltage is clamped by a capacitor voltage.

19. The direct electric vehicle charger of claim 1, wherein the non-insulated dc/dc converter is a unidirectional buck converter in which a buck switch configured by connecting a forward active switch and a reverse diode in series is connected to both ends of the input power, one end of an inductor is connected to a middle point of the buck switch, the other end of the inductor and a (+) terminal of the output capacitor are connected, and a (−) terminal of the output capacitor and a (−) terminal of the input power are connected.

20. The direct electric vehicle charger of claim 19, wherein the unidirectional buck converter controls a duty ratio of the buck switch to have a ripple in a direction opposite to the ripple of the output voltage of the rectifier to constantly control the output voltage or output current.

21. The direct electric vehicle charger of claim 1, wherein the non-insulated dc/dc converter is a unidirectional buck-booster converter in which a buck switch configured by connecting a forward active switch and a reverse diode in series is connected to both ends of the input power, a booster switch configured by connecting the reverse diode and the forward active switch in series is connected to both ends of an output capacitor, and an inductor is connected between a middle point of the buck switch and a middle point of the booster switch.

22. The direct electric vehicle charger of claim 1, wherein the non-insulated dc/dc converter has a buck converter structure configured to perform directional power conversion in which a bidirectional buck switch configured by connecting two first switches in series is connected to both ends of the input power, the first switch being configured by connecting a forward active switch and a diode in anti-parallel, one end of an inductor is connected to a middle point of the directional buck switch, the other end of the inductor and a (+) terminal of an output capacitor are connected, and a (−) terminal of the output capacitor and a (−) terminal of the input power are connected.

23. The direct electric vehicle charger of claim 1, wherein the non-insulated dc/dc converter is a bidirectional buck-booster converter in which a bidirectional buck switch configured by connecting the two first switches in series is connected to both ends of the input power, the first switch being configured by connecting a forward active switch and a diode in anti-parallel, a bidirectional booster switch configured by connecting the two first switches in series is connected to both ends of an output capacitor, and an inductor is connected between a middle point of the bidirectional buck switch and a middle point of the bidirectional booster switch.

24. The direct electric vehicle charger of claim 1, wherein the non-insulated dc/dc converter is a unidirectional booster-buck converter in which a booster switch configured by connecting a reverse diode and a forward active switch in series is connected to both ends of a dc-link capacitor, one end of an inductor is connected to a middle point of the booster switch, the other end of the inductor is connected to a (+) terminal of an output of the rectifier, a booster converter configured by connecting a (−) terminal of the output of the rectifier and a (−) terminal of the dc-link capacitor to each other and a buck switch configured by connecting the forward active switch and the reverse diode in series are connected to both ends of the dc-link capacitor, one end of an inductor is connected to a middle point of the buck switch, the other end of the inductor is connected to a (+) terminal of an output capacitor, and the (−) terminal of the dc-link capacitor and a (−) terminal of the output capacitor are connected.

25. The direct electric vehicle charger of claim 1, wherein the non-insulated dc/dc converter is a bidirectional booster-buck converter including:
a bidirectional booster converter in which a bidirectional booster switch configured by connecting two first switches in series is connected to both ends of a dc-link capacitor, the first switch being configured by connecting a forward active switch and a diode in anti-parallel, an inductor is connected between a middle point of the bidirectional booster switch and a (+) terminal of an output of the rectifier, and a (−) terminal of the output of the rectifier and a (−) terminal of a dc-link capacitor are connected to each other; and
a bidirectional buck converter in which a bidirectional buck switch configured by connecting the two first switches in series is connected to both ends of the dc-link capacitor, one end of an inductor is connected to a middle point of the bidirectional buck switch, the other end of the inductor is connected to a (+) terminal of an output capacitor, and the (−) terminal of the dc-link capacitor and a (−) terminal of the output capacitor are connected.

26. The direct electric vehicle charger of claim 22, wherein the non-isolated dc/dc converter reduces a conduction loss of the diode by turning on the active switch connected in anti-parallel when the diode conducts.

27. The direct electric vehicle charger of claim 23, wherein the non-isolated dc/dc converter reduces a conduction loss of the diode by turning on the active switch connected in anti-parallel when the diode conducts.

28. The direct electric vehicle charger of claim 25, wherein the non-isolated dc/dc converter reduces a conduction loss of the diode by turning on the active switch connected in anti-parallel when the diode conducts.

29. The direct electric vehicle charger of claim 26, wherein the active switch is a metal oxide semiconductor field effect transistor (MOSFET) having a body diode embedded therein.

30. The direct electric vehicle charger of claim 27, wherein the active switch is a metal oxide semiconductor field effect transistor (MOSFET) having a body diode embedded therein.

31. The direct electric vehicle charger of claim 28, wherein the active switch is a metal oxide semiconductor field effect transistor (MOSFET) having a body diode embedded therein.

32. The direct electric vehicle charger of claim 13, wherein the energy regenerative rectifier reduces a conduction loss of the diode by turning on the active switch connected in anti-parallel with the diode while the diode conducts even during charging by forward power conversion.

33. The direct electric vehicle charger of claim 32, wherein the energy regenerative rectifier has a certain dead time so that the turning on and off of the active switch do not overlap each other when the active switch is turned on and off between the phases.

34. The direct electric vehicle charger of claim 33, wherein the energy regenerative rectifier performs bidirectional power conversion by connecting a clamp circuit having a diode and a capacitor connected in series between the (+) and (−) terminals of the output terminal of the rectifier, turning on the diode when a voltage of the rectifying terminal is increased, clamping the voltage of the rectifying terminal by the capacitor voltage, and discharging clamp energy accumulated in a clamp capacitor through a resistor.

35. The direct electric vehicle charger of claim 33, wherein the energy regenerative rectifier performs bidirectional power conversion by connecting a clamp circuit having a capacitor connected in series with the active switch connected in anti-parallel with the diode between the (+) and (−) terminals of the output of the rectifying terminal to prevent the voltage of the rectifying terminal from increasing during the dead time, turning on the diode when the voltage of the rectifying terminal increases, clamping the voltage of the rectifying terminal by the capacitor voltage, and discharging clamp energy accumulated in a clamp capacitor so that the capacitor voltage constantly remains by turning on the active switch when the clamp ends and the diode is turned on.

36. The direct electric vehicle charger of claim 13, wherein the energy regenerative rectifier includes a battery energy storage system or a photovoltaic power generation device at an output end.

37. A non-insulated dc/dc converter of the direct electric vehicle charger of claim 1, wherein when the non-insulated dc/dc converter is configured as a buck-boost converter in which a buck converter and a boost converter are sequentially connected, or a booster-buck converter in which a booster converter and a buck converter are sequentially connected,
the buck-booster converter or the booster-buck converter is a zero-voltage switching buck-booster converter or booster-buck converter in which an auxiliary circuit in which a resonant inductor and an auxiliary switch are connected in series is connected between a middle point of a buck switch and a middle point of a booster switch, switching periods of the buck switch and the booster switch are synchronized, a current in the resonant inductor is increased by turning on the auxiliary switch before a freewheeling mode of the buck converter and the booster converter ends, a freewheeling diode is turned off when the current of the resonant inductor becomes larger than a freewheeling current of the buck converter and the booster converter, and a powering switch is turned on at zero voltage when an anti-parallel diode of the powering switch conducts.

38. The non-insulated dc/dc converter of claim 37, wherein the auxiliary circuit includes two clamp diodes respectively connected between a point where the resonant inductor and the auxiliary switch are connected and both ends of the switch (buck switch or booster switch) to which the resonant inductor is connected.

39. The non-insulated dc/dc converter of claim 37, wherein when increasing the current in the resonant inductor by turning on the auxiliary switch using a bidirectional buck switch and a bidirectional booster switch in the zero-voltage switching buck-boost converter and the zero-voltage switching booster-buck converter, a switching time margin for zero-voltage switching is increased by continuously turning on active switches connected in anti-parallel to freewheeling diodes of the buck switch and the booster switch and the active switch to make the resonance current larger than the freewheeling current by a certain portion and then turning off the active switches connected in anti-parallel to the freewheeling diodes.

40. The non-insulated dc/dc converter of claim 37, wherein the auxiliary switch is a type in which the diode and the first switch are connected in series when the buck-boost converter or the booster-buck converter only performs unidirectional power conversion.

41. The non-insulated dc/dc converter of claim 37, wherein the auxiliary switch is a type in which the two first switches face each other and are connected in series when the bidirectional buck-boost converter or the bidirectional booster-buck converter performs bidirectional power conversion.
